(19) United States
(12) Patent Application Publication
(10) Pub. No.: US 2002/0078372 A1
(43) Pub. Date: Jun. 20, 2002

(54) Systems and methods for protecting information on a computer by integrating building security and computer security functions

(76) Inventors: Gaspare Aluzzo, Annapolis, MD (US); William Bigno, Woodbridge, VA (US)

Correspondence Address: Finnegan, Henderson, Farabow,, Garrett & Dunner, L.L.P., 1300 I Street, N.W., Washington, DC, 20005-3315, US

(21) Appl. No.: 09/950,508

(22) Filed: Sep. 10, 2001

Related U.S. Application Data
(60) Provisional application No. 60/231,333, filed on Sep. 8, 2000.

(51) Int. Cl. H04L 9/32

(52) U.S. Cl. 713/200

(57) ABSTRACT

An embodiment of the invention is a method for controlling access to a computer having an authorized computer access token and a computer access token reader in communication with the computer. The computer is housed in a building with an entrance controlled by an authorized building access token and a building access token reader and the computer is in communication with the building access token reader. The method comprises logging in a person seeking computer access with the authorized building access token at the building access token reader. A check is performed for the authorized computer access token at the computer access token reader. Another check is performed to determine whether the person associated with the authorized computer access token has logged into the building access token reader. The computer is disabled if the person associated with the authorized computer access token has not logged in with the authorized building access token at the building access token reader.

### RELATED APPLICATIONS

This application claims the benefit of priority from Provisional U.S. Patent Application Serial No. 60/231,333, entitled “SYSTEMS AND METHODS OF PROTECTING INFORMATION ON A COMPUTER BY INTEGRATING BUILDING SECURITY AND COMPUTER SECURITY FUNCTIONS,” filed on Sep. 8, 2000, by the same inventors, which is expressly incorporated herein by reference.

Additionally, this application is related to commonly owned U.S. patent application Ser. No. ______, entitled “SYSTEM AND METHOD FOR PROTECTING INFORMATION STORED ON A COMPUTER,” filed on the same date herewith by the same inventors.

### BACKGROUND OF THE INVENTION

1. Field of the Invention

The present invention relates to the field of computer security, and, more specifically, to computer access control systems in which computer security and building security functions are integrated.

2. Background and Material Information

Computer security systems using keys or passwords are well known. However, these systems provide only a single layer of security to a computer, which may be easily circumvented. When given access to a computer, an unauthorized user has a greatly increased chance of divining the password or physically manipulating the computer so as to render the computer's security system useless.

Many modern buildings have automated systems for checking the credentials of those seeking access to a building. For example, a radio frequency (RF) tag may be implanted in an identification badge so that a user can pass the badge by a tag reader at a building access point, such as an entrance. Since each user typically has a unique identifier, a computer monitoring the tag reader may determine whether the user is authorized to access the entrance by associating the identifer with the user. When the user is authenticated at the building entrance, the entrance is unlocked to provide entry.

Other variations of this system exist, such as a manned security checkpoint which requires a proper electronic token to be presented to a reader. The security guard would not provide access unless and until this electronic token is presented and a computer authenticates the user.

Nevertheless, known computer security systems essentially operate in a vacuum by failing to integrate computer security with building security. For example, known computer security systems do not consider whether the person seeking computer access has successfully and properly gained entrance to the building in which the computer resides.

In this way, known computer security systems fail to account for data provided by electronic building security devices, such as those data provided by building entrances controlled by token reading devices. For example, a person who steals a key or password for a computer can sneak into a building past a controlled building entrance and easily access the computer despite the fact the person did not log into the security system.

In any automated building security system, authorization data are available for exportation to other computer systems. For example, a building security system may be queried by another computer system to determine whether a particular user has been authorized and has entered the building.

What is needed is a computer access security system which queries a building security system to determine if a potential user has been authenticated at a building security checkpoint. The computer access security system should only allow access to the computer when data confirming proper building access for the potential user have been received at the computer security system.

### SUMMARY OF THE INVENTION

Methods, systems, and computer-readable media consistent with the present invention overcome these problems and provide enhanced security measures. In one aspect of the invention, a method consistent with an embodiment of the present invention is described for controlling access to a computer having an authorized computer access token and a computer access token reader in communication with the computer. The computer is housed in a building with an entrance controlled by an authorized building access token and a building access token reader and the computer is in communication with the building access token reader. The method comprises logging in a person seeking computer access with the authorized building access token at the building access token reader. A check is performed for the authorized computer access token at the computer access token reader. Another check is performed to determine whether the person associated with the authorized computer access token has logged into the building access token reader. The computer is disabled if the person associated with the authorized computer access token has not logged in with the authorized building access token at the building access token reader.

In another aspect, a system consistent with an embodiment of the invention is also disclosed for protecting information when accessing a building with a plurality of entrances. The system comprises a computer housed in the building, a plurality of building access token readers, each of which being disposed substantially proximate to each of the entrances, a computer access token reader in communication with the computer, a building access token, and a computer access token. The computer access token reader may be in communication with the building access token readers. The computer is disabled if a person seeking computer access places the computer access token in the computer access token reader when the person associated with the computer access token has not logged in with the building access token at one of the building access token readers.

Additional advantages of the invention will be set forth in part in the description which follows, and in part will be obvious from the description, or may be learned by practice of the invention. The advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several embodiments of the invention and together with the description, serve to explain the principles of the invention.

Reference will now be made in detail to the present embodiments of the invention, examples of which are illustrated in the accompanying drawings. Wherever possible, the same reference numbers will be used throughout the drawings to refer to the same or like parts.

In the drawings:

FIG. 1 is a diagram of an exemplary system environment in which to practice an embodiment of the present invention;

FIG. 2 is a flowchart of an exemplary method in accordance with an embodiment of the present invention;

FIG. 3 is a flowchart of an exemplary subroutine in accordance with an embodiment of the present invention;

FIG. 4 is a flowchart of an exemplary subroutine in accordance with an embodiment of the present invention

FIG. 5 is a flowchart of an exemplary subroutine in accordance with an embodiment of the present invention;

FIG. 6 is a flowchart of an exemplary method for utilizing public key infrastructure (PKI) encryption and/or decryption in accordance with an embodiment of the present invention;

FIG. 7 illustrates a flowchart of an exemplary method for checking to determine whether a user is authenticated to access files in static memory consistent with an embodiment of the present invention

FIG. 8 is a diagram of an exemplary system environment for integrating computer security with building security in accordance with an embodiment of the present invention;

FIG. 9 is a flowchart of an exemplary method in accordance with an embodiment of the present invention; and

FIG. 10 is a flowchart of an exemplary method for querying a building security system in accordance with an embodiment of the present invention.

### DESCRIPTION OF THE EMBODIMENTS

Embodiments of the present invention provide for the advantageous integration of the building security and computer access security functions into a single system that prevents unauthorized access to a computer system, thereby protecting information in the computer system. In this way, data from building security access devices are provided to a computer security system in a way that allows the computer security system to add a new layer of security.

Embodiments of the present invention contemplate that the building security system and the computer to be protected be networked or otherwise operatively connected. In this way, the computer may access electronic data provided by the building security system in determining when to allow a user to access the computer.

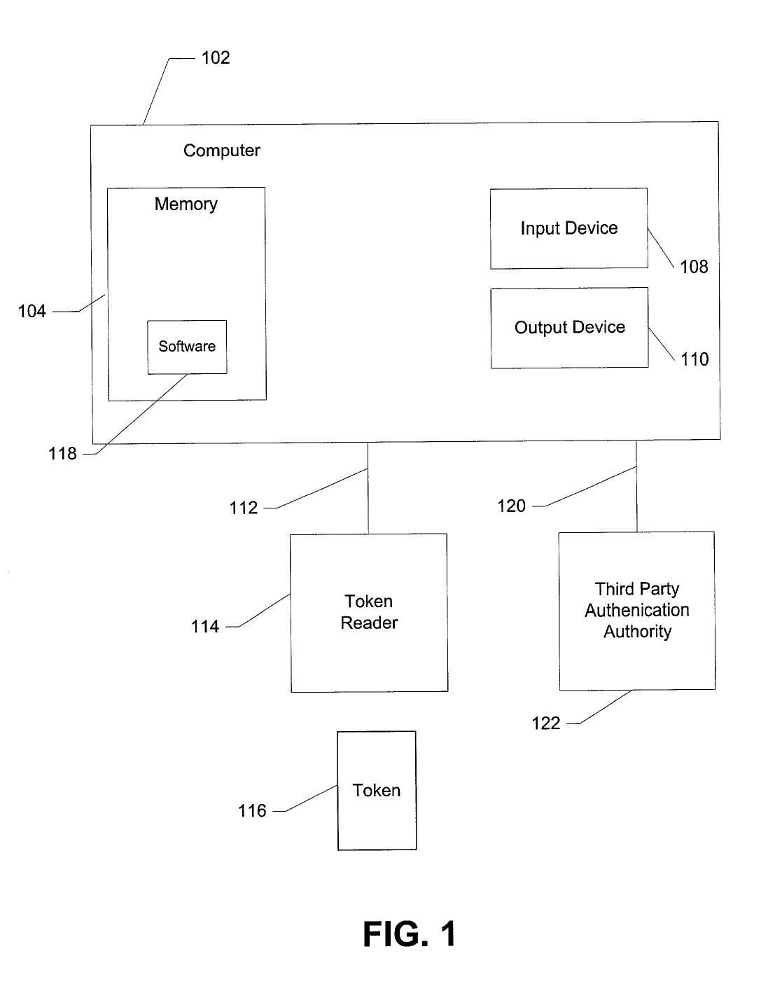

Referring to FIG. 1, an exemplary system environment is illustrated in which to practice an embodiment of the present invention. In this exemplary embodiment, a computer 102 includes a memory 104, at least one input device 108, and at least one output device 110. Input device 108 may comprise, by way of example but not of limitation, a mouse, a keyboard, a microphone, a joystick, a trackball, a touch screen reader, a scanner, and the like. Output device 110 may comprise, by way of example but not of limitation, a printer, a plotter, a monitor, a speaker, and the like.

Computer 102 is operatively connected to a token reader 114 by link 112. One skilled in the art will recognize that the connection may include a port or communication interface (not shown) comprising, among other things, switches. Nevertheless, the present invention contemplates any suitable implementation of a communication interface. A token 116 is to be used with reader 114 for providing authenticated access to computer 102. Token reader 114 may comprise, for example, a Smart Card reader, a radio frequency (RF) tag reader, a magnetic stripe reader, a retinal scanner, a fingerprint reader, a palmprint reader, and the like. Correspondingly, token 116 may comprise, for example, a Smart Card, an RF tag, a token having a magnetic stripe, or the retina, fingerprint, or palmprint from a user (not shown). Generally, token 116 stores (by design or merely by coincidence) the encoded authenticating information for the user.

When token 116 is placed in contact with, in proximity of, or in operative engagement with token reader 114, token reader 114 verifies authenticating information encoded in or on token 116. This authenticating information is then sent to computer 102 via link 112 and a communication interface (not shown) of computer 102.

In the exemplary embodiment, token reader 114 may secure and retain token 116 during the process of authenticating a token 116 described above. Furthermore, token reader 114 may secure and retain token 116 during the usage of computer 102 after token 116 is authenticated. In this way, when token 114 is removed from token reader 114, computer 102 may check for authenticity and disallow further use of the input device 108, the output device 110, and/or any other computer functionality. Token 116 may also be fixably attached to the user or the user's person, such that when the user leaves the computer terminal, token 116 is removed from token reader 114. In this way, authenticated access to the input device 108, the output device 110, and/or any other computer functionality will be given only when token 116 is present in token reader 114.

Thus, software 118 operational in memory 104 may disable at least one input device 108 during a bootup operation if an authenticated token 116 is not present in reader 114. Alternately, software 118 operational in memory 104 may disable at least one output device 110 during a bootup operation if authenticated Smart Card 116 is not present in reader 114. Moreover, at least one input device (such as input device 108) and/or at least one output device (such as output device 110) may be disabled when an authenticated Smart Card 116 is not present in reader 114 while the OS is operational in memory 104.

In an exemplary embodiment utilizing public key infrastructure (PKI) for encryption and/or decryption of data, computer 102 sends authenticating information to a third party certification authority 122 via link 120. Third party certification authority 122 may then send an electronic permission indicator back to computer 102 via link 120. Third party certification authority 122 may comprise any a trusted third party responsible for issuing authentications, such as Entrust, VeriSign, Baltimore Technologies, and RSA Security, for example. When computer 102 receives the electronic permission indicator, computer 102 is then authorized to either encrypt or decrypt data.

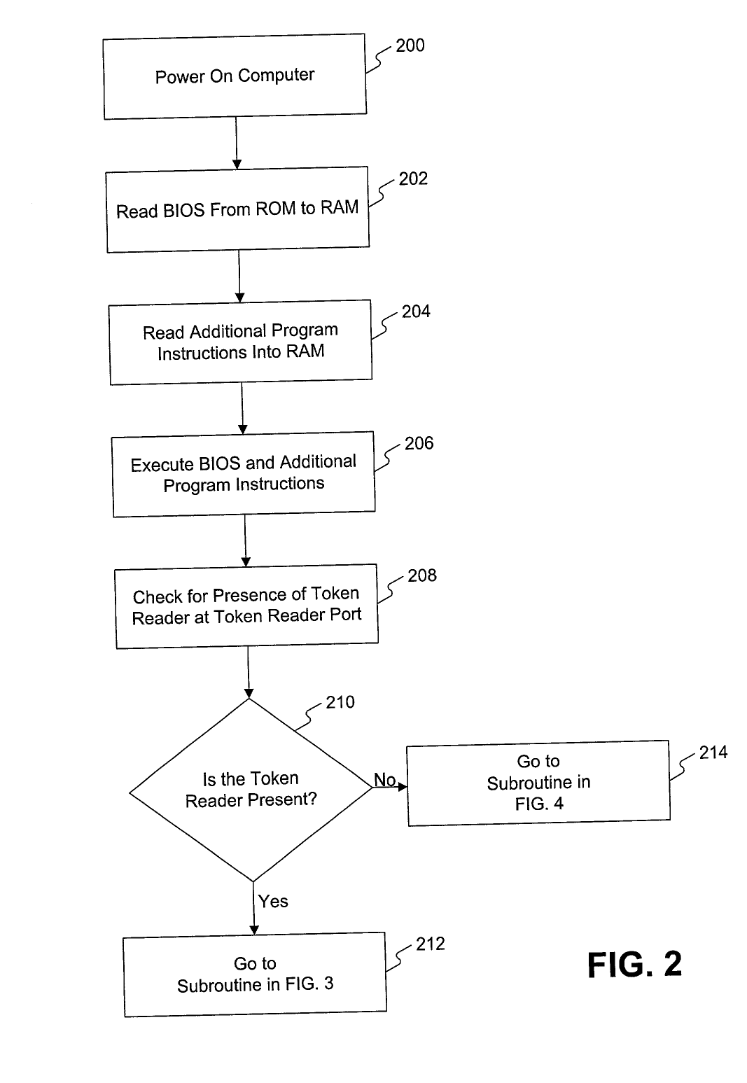

Turning to FIG. 2, an exemplary method in accordance with an embodiment of the present invention will be illustrated. In step 200, a computer is powered on or otherwise booted. BIOS instructions are read from read-only memory (ROM) to random access memory (RAM) in step 202. Along with these BIOS instructions, additional program instructions are read into RAM relating to token reader 114 (step 204). These extra instructions may be read into RAM immediately after BIOS instructions are read into RAM. Thus, instructions for both the BIOS and Smart Card system are executed substantially coincidentally, as shown in step 206.

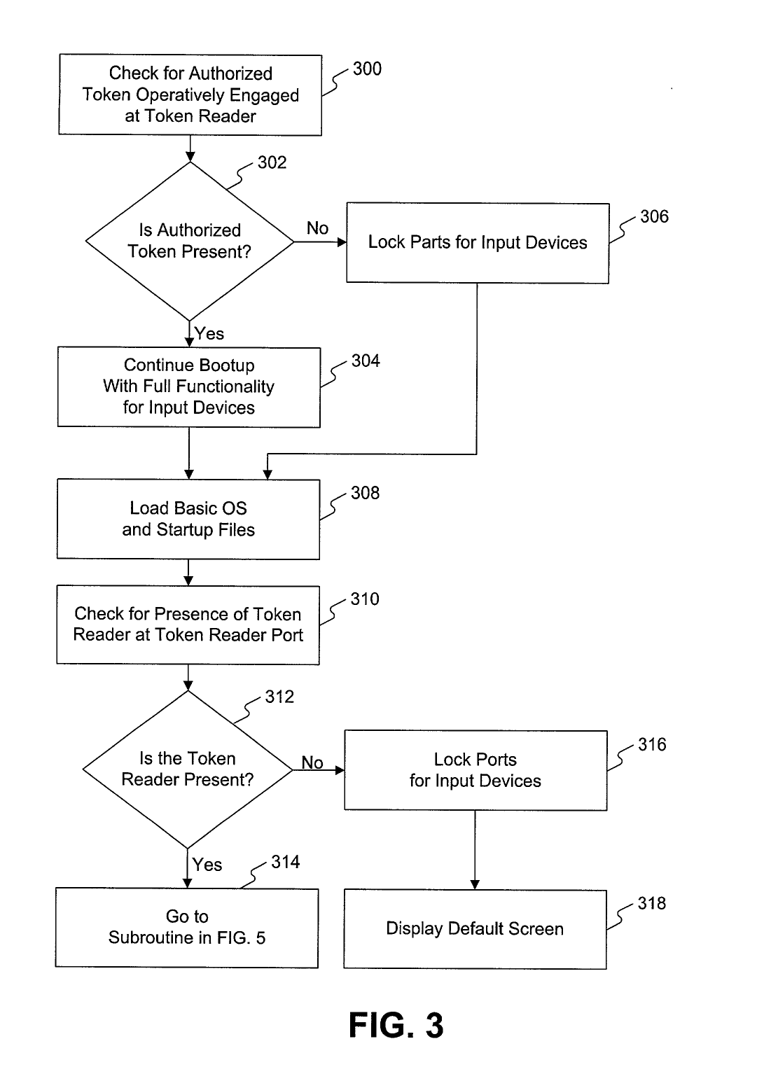

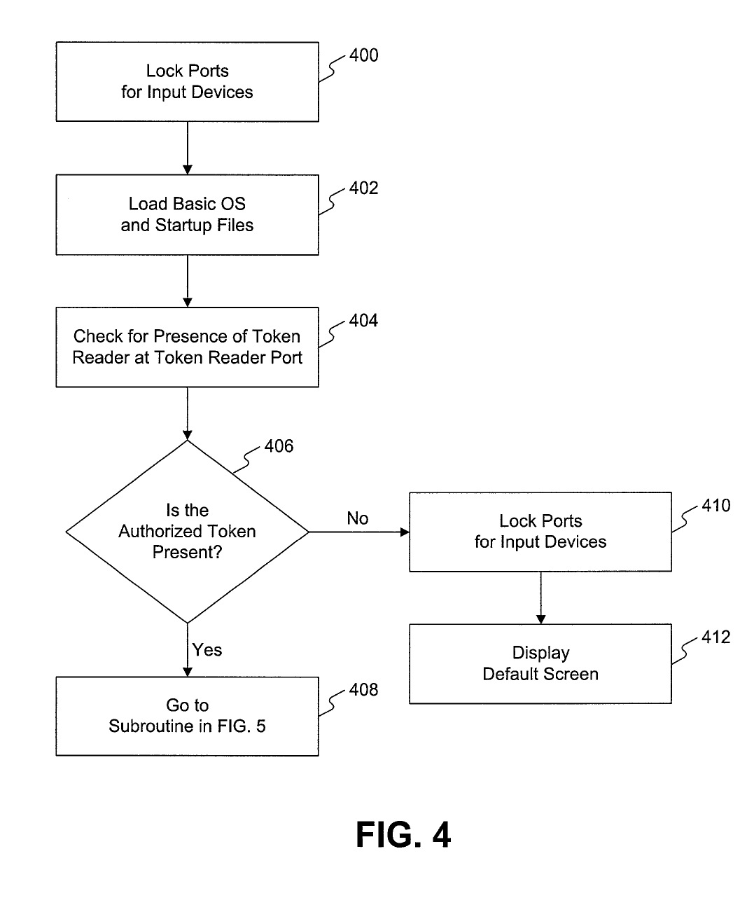

When these instructions are executed, the computer performs a check to see if a token reader is present (step 208). A determination is made in step 210 whether a token reader is present. If the reader is present, the method advances to the subroutine of FIG. 3 described below (step 212). If the reader is not present, the method advances to the subroutine of FIG. 4 described below (step 214).

An exemplary subroutine in accordance with an embodiment of the present invention will now be described with reference to FIG. 3. This exemplary subroutine is typically performed only if a token reader is present in step 212 of FIG. 2. At step 300, a check is performed to determine if an authenticated token is operatively engaged at token reader 114. In step 302, a determination is made whether an authenticated token is present at the token reader 114. If an authenticated token is present, the subroutine advances to step 304. Normal bootup is continued in step 304 with full functionality for the at least one input device 108. If an authenticated token is not present, however, the subroutine advances to step 306, where a port or other type of communication interface corresponding to the at least one input device 108 is locked.

The port may be locked via an instruction (e.g., a binary instruction) implemented in software which may, for example, engage a switch. By engaging the switch, all signals coming from the at least one input device are interrupted, effectively locking the at least one input device. Step 306 serves to disable the at least one input device 108 so that a would-be thief (more generally referred to as a potential user) would be thwarted in using the input devices of the computer to circumvent security measures. Thus, the computer is locked at the BIOS level (i.e., before the OS is operational) because a user cannot manipulate the computer even when the BIOS is operational. In addition, in the case where an unauthenticated token has been presented at token reader 114, step 306 may further comprise detaining the unauthenticated token in the computer access token reader 114.

In step 308, conventional OS files and startup files are loaded from ROM or from static memory to RAM, and these files are executed in a normal fashion. For example, in a Microsoft DOS operating system, CONFIG.SYS, AUTOEXEC.BAT, and other various OS files are typically processed at this step. Those skilled in the art will be familiar with the bootup process for the Microsoft DOS operating system as well as for other computer systems.

The method advances to step 310, where a check is performed to determine if an authenticated token is operatively engaged at token reader 114. The purpose of this check is to determine whether a reader may have been connected by a would-be thief, only to be removed once the BIOS security checks have been surpassed. In contrast to the previous check, which operated at the BIOS level, this check provides a measure of protection at the OS level. In step 312, a determination is made whether the token reader is still present to the computer system. If a token reader is not present at this check, the method advances to step 316, where the at least one input device 108 is locked. In the exemplary embodiment, locking of the at least one input device 108 is accomplished in the same manner described above: A binary instruction engages a switch, thereby interrupting signals from the at least one input device.

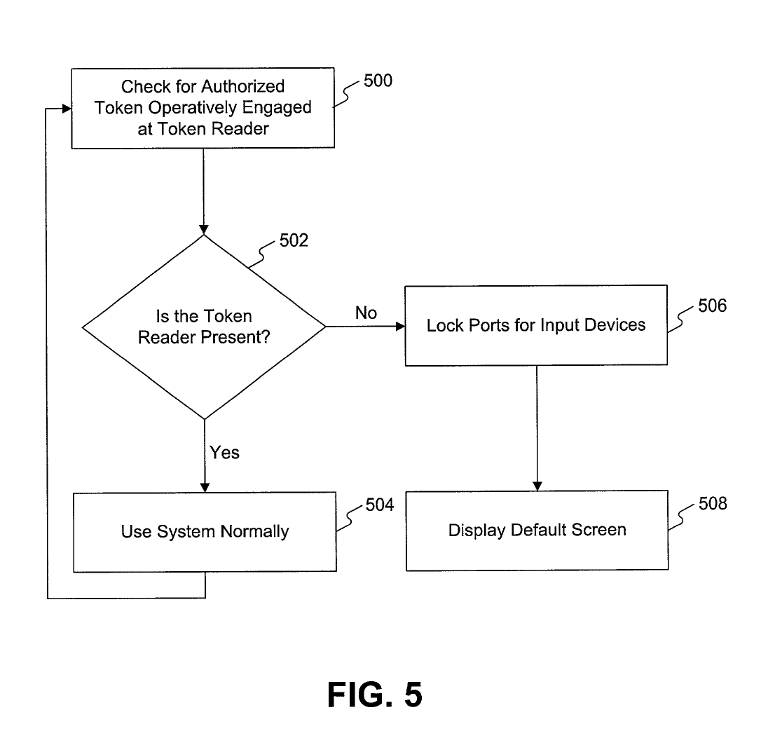

Step 316 effectively disallows the user from manipulating computer functions in any way. Further, in step 318, a default screen is displayed which overrides normal computer displays. This default screen may comprise, for example, a monochromatic screen display or a default message display (e.g., “Computer Locked”). Optionally, the monitor may be powered down by the computer, revealing a blank screen. If a token reader is present at step 312, the method advances to the subroutine shown in FIG. 5, as described below (step 314).

Now with reference to FIG. 4, an exemplary subroutine according to an embodiment of the present invention will be described. The exemplary subroutine of FIG. 4 corresponds to the situation where a token reader is not present at the first check. In step 400, ports corresponding to the at least one input device 108 are locked, thus preventing a computer user from manipulating computer function in any way. In step 402, conventional OS files and startup files are loaded from ROM or from static memory to RAM, and these files are executed in a normal fashion. The method advances to step 404, where a check is performed for the presence of the token reader at the token reader port. The purpose of this check is to determine whether a reader may have been connected by a would-be thief, only to be removed once the BIOS security checks have been surpassed.

In step 406, a determination is made whether the token reader is still present to the computer system. If a token reader is not present at this check, the method advances to step 410, where the input devices are locked. Further, in step 412, a default screen is displayed which overrides normal computer displays. If a token reader is present at step 406, the method advances to the subroutine shown in FIG. 5, as described below (step 408).

FIG. 5 illustrates a flowchart of a subroutine in accordance with the present invention. In step 500, a check is performed to determine whether an authenticated token is operatively engaged at the token reader. In step 502, a determination is made whether an authenticated token is present at the token reader 114. If an authenticated token is not present at this check, the method advances to step 506, where the input devices are locked and step 508, where a default screen is displayed, the default screen typically overriding normal computer displays. If an authenticated token is present at step 502, normal computer function is available (step 504).

Once a user has access to full computer functionality, the computer may perform an ongoing check that the authenticated token is still present. This is represented by the loop back from step 504 to step 500 in FIG. 5. In this way, when an authenticated user removes an authenticated token from the token reader 114, the ongoing check will cause the computer to immediately engage the locking feature of step 504 and the default screen of step 508.

In practice, embodiments of the present invention allow a user to boot a computer even when an authenticated token is not present. In this situation, however, the input devices are locked during bootup, so as to thwart an unauthorized user's attempt to override the bootup and to place the computer in a “Safe Mode,” for example. Therefore, the computer cannot be manipulated by an unauthorized user during the bootup sequence. Correspondingly, authenticated users may boot their computers without waiting for an authenticated token to be present. Thus, authenticated users need not later wait through the bootup sequence if they neglect to place their authenticated token in the reader at startup.

The OS-level check for an authenticated token allows an authenticated user to alternate between locked and unlocked modes at the OS level. The lock is activated simply by removing the token. For example, if a user temporarily leaves the computer and takes the authenticated token from the reader, the computer reverts to its locked mode. When the user returns and replaces the authenticated token in the reader, full functionality is restored.

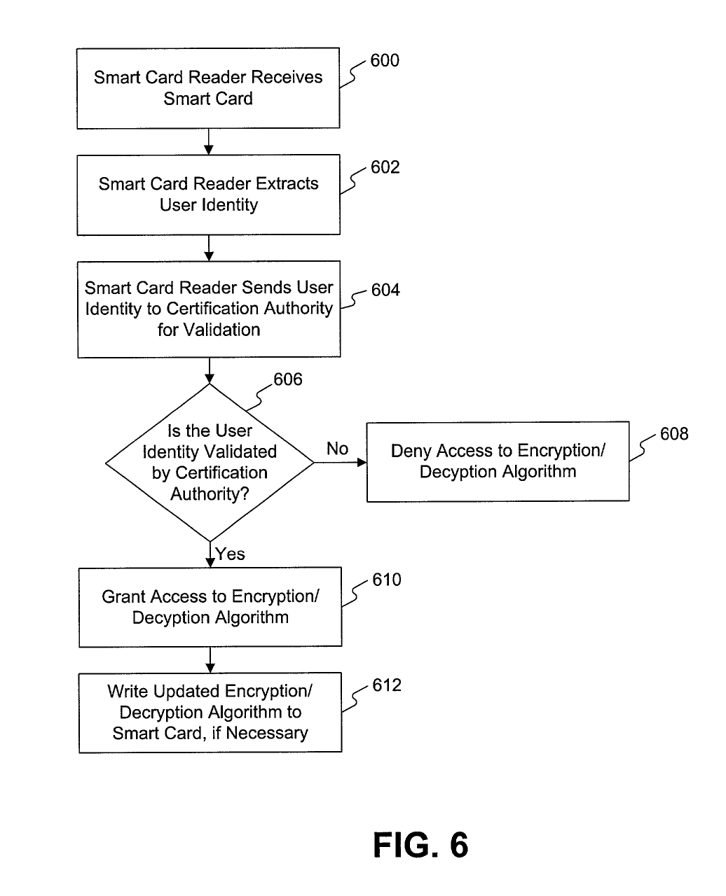

Now with reference to FIG. 6, the exemplary method for authenticating a user (as described above) may be integrated with a public key encryption scheme (i.e., PKI) for encryption and/or decryption of data. Moreover, the token the user presents for authentication may be utilized in the PKI system for storing a user identity and public and/or private encryption keys. While the method of FIG. 6 will be described utilizing a Smart Card for the token, those skilled in the art will appreciate that any type of token, besides the specific example of a Smart Card, is contemplated by the principles of the present invention.

Turning to FIG. 6, a Smart Card reader receives a Smart Card in step 600. The reader extracts a user identity from the Smart Card in step 602 and sends the user identity to third party certification authority 122 for validation in step 604. A determination is made whether the user identity is validated at third party certification authority 122 in step 606. Step 606 serves to verify the identity of the user presenting the Smart Card. If user identity is not verified in step 606 (“No”), then the potential user is denied access to the PKI application, as shown in step 608. If the user identity is verified in step 606 (“Yes”), user is authorized to access the PKI application in step 610.

As is known in the art, the user's public and private keys are periodically changed pursuant to the PKI process. A change interval for updating the public and private keys may be determined by a PKI administrator at third party certification authority 122. If a user is authorized to access the PKI encryption/decryption algorithm in step 610, and if the change interval has expired, updated public and/or private keys may be written to the Smart Card in step 612.

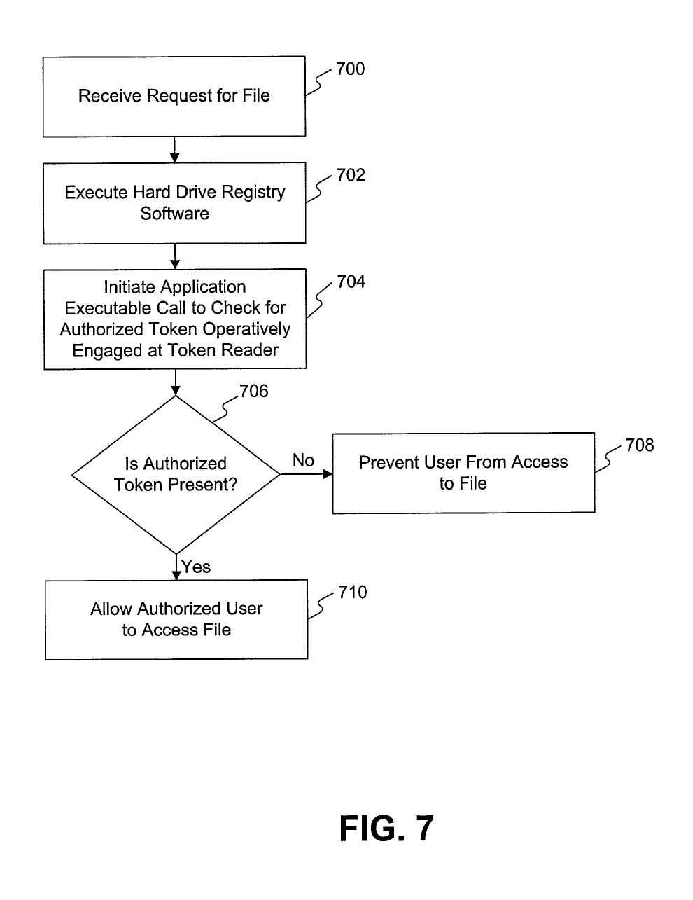

FIG. 7 illustrates a flowchart of an exemplary method for checking to determine whether a user is authenticated to access files in static memory, such as the hard drive, consistent with an embodiment of the present invention. As mentioned previously, coding resident in the hard drive ensures that only authorized users have access privileges to certain files. Access privileges define the extent to which a user may access a file to, for example, view, modify, or create its contents. The access privileges for files on the hard drive are defaulted to a protected or inaccessible state. One skilled in the art may exclude some system files from this default inaccessible state so as to allow access to such files.

At step 700, the computer receives a request to access a file from a user or from a program which the user is operating. In the exemplary embodiment, a software module, referred to as hard drive registry software, is then executed in step 702. As is known in the art, a “registry” is a repository for all the miscellaneous settings such as, for example, how computer memory is set up and what application programs are to be present when the OS is started. “Registry software” refers to software capable of implementing those settings. Substantially coincidental with the execution of the hard drive registry software, an application executable call checks to determine whether an authenticated token is operatively engaged at token reader 114 (step 704). As a result of this application executable call, a determination is made whether an authenticated token is present at the token reader 114 in step 706. If the user is not authenticated to access the file, the access privileges are left unchanged, leaving the file inaccessible (step 708). If the user is authenticated to use the file, the access privileges for the file are changed from the default (i.e., inaccessible) to an accessible state, as shown in step 710. Thus, the exemplary method of FIG. 7 prevents an unauthorized user from accessing the protected files.

An aspect of the exemplary method of FIG. 7 is that the method may protect memory 104 even if it is physically removed from the computer. For example, if a hard drive is physically removed from a computer, an unauthorized user cannot install the hard drive on another computer and access the data thereon. Similarly, if a hard drive is physically removed from a computer, an unauthorized user cannot install the hard drives a “slave” to another computer and access the data thereon. Thus, access to memory 104 is only available when an authenticated token is placed in token reader 116.

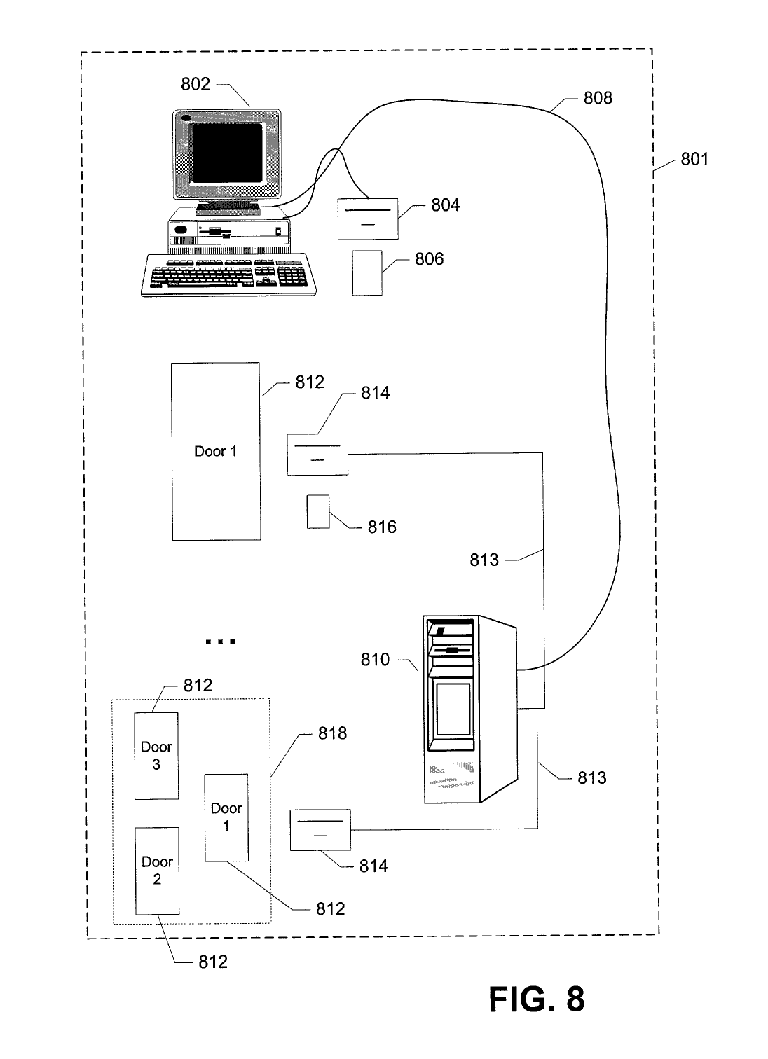

Turning to FIG. 8, which shows an exemplary system in accordance with an embodiment of the present invention, a building 801 houses a computer 802. The building 801 is represented symbolically by a dashed perimeter. The computer 802 has a computer access token reader 804 adapted to read a computer access token 806. Further, computer 802 is linked by network link 808, such as a cable or network connection, to the network supporting a building security system 810. Building security system 810 oversees at least one controlled entrance 812. Each of the at least one controlled entrances 812 is nearly or substantially proximate to a building access token reader 814 such that the building access token reader 814 may be conveniently used to gain access of the respective controlled entrance 812. Each building access token reader 814 is operatively connected to building security system 810 via a door link 813, which may be wired or wireless in implementation. The token-reading system may utilize any suitable recognition technology, such as those described with reference to FIGS. 1-7, including radio frequency (RF), magnetic stripe, proximity reader, fingerprint recognition, palmprint recognition, voice recognition, eye recognition, or Smart Card technology, for example. A token for use with such technologies is represented by a building access token 816. Depending on design and security considerations for a given implementation, building access token 816 can be used at one, certain, or all of the controlled entrances 812 to gain building access. Alternatively, a building access token reader 814 may control access to a group or “zone” of controlled entrances 812, the zone being symbolically illustrated by dashed perimeter 818. Building access token 816 may be used in its traditional fashion, i.e., to permit or deny entry into building 801.

In an exemplary embodiment of the present invention, a person seeking computer access first presents a building access token 816 at a building access token reader 814. In this manner, the person seeking computer access presents his or her building access token 814 to gain entry into the building 801, thus logging the person ultimately seeking computer access into building security system 810. For purposes of the present invention, “logging in” describes the process by which record of a person properly gaining entry to a building is recorded by electronic or manual means. For instance, each record may include identifying information about the person properly gaining entry, a point of entry, a time of entry, and a date of entry.

When the person seeking computer access proceeds to computer 802, he or she presents computer access token 806 to computer access token reader 804. Alternately, the computer may accept a password or key or other recognition mechanism or device as the computer access token. Computer 802 then queries building security system 810 to determine whether the person associated with computer access token 806 has logged into building security system 810. Only if this is true will computer 802 provide access to the computer by the person seeking such access. Otherwise, computer 802 will be disabled, rendering access impossible.

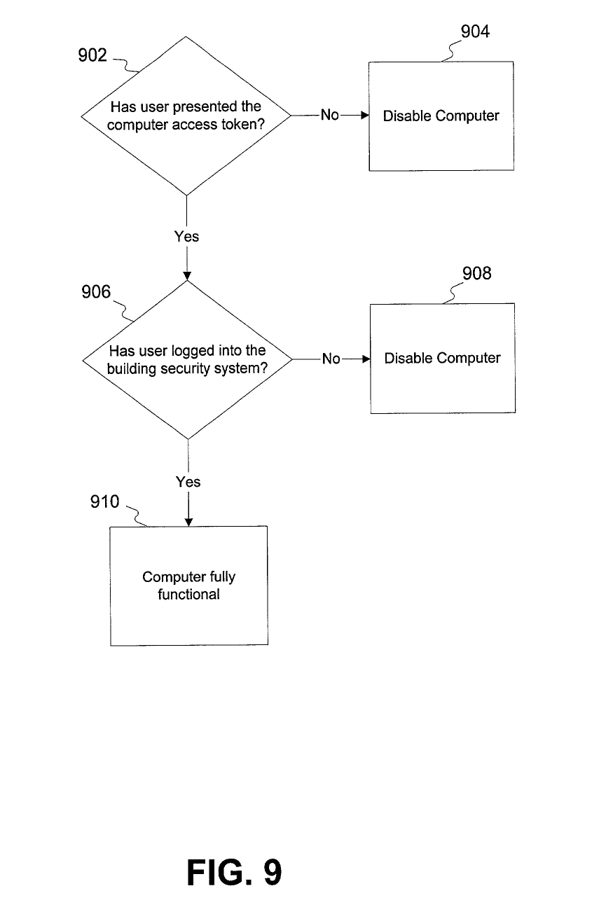

FIG. 9 illustrates an exemplary method for preventing access to a computer according to an embodiment of the present invention. The exemplary method provides two sets of checks when a user attempts to access computer 802. First, computer 802 checks to see whether the computer key or token is present, or alternately, to see if the password has been entered properly (step 902). This first check ensures that a user with the correct key, token, or password is present at the computer terminal. If the computer key or token is not present, the computer is disabled (step 904).

The second check has the computer 802 initiating a query to the building security system. As such, the computer will check to see that the authorized user associated with the key, token, or password presented to the computer in the first check has logged into the building security system (step 906). If the authorized user has logged into the building security system, the computer works normally with full functionality (step 910). However, if the authorized user has not logged into the building security system, the computer is disabled and will not function (step 908).

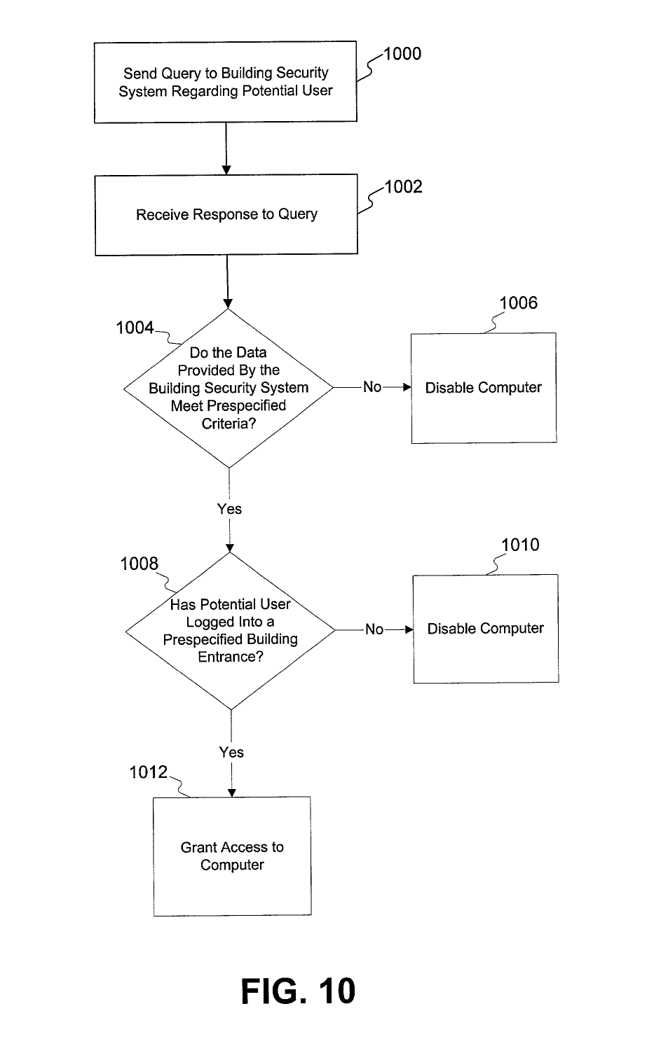

Turning to FIG. 10, an exemplary method is illustrated for querying a building security system consistent with an embodiment of the present invention. The exemplary method is shown from the perspective of the computer security system. In step 1000, the computer security system sends a query to the building security system regarding a potential computer user. The query may include a request for information regarding the potential user's building entry time, security clearances, entrances accessed, and the like. In step 1002, the computer security system receives a response to the query from the building security system. In step 1004, these data are processed in the computer security system. A determination is made whether the data meet prespecified criteria. These prespecified criteria may comprise, for example, an amount of time since logging in at a building access token reader (e.g., a maximum time period), a level of security clearance (e.g., a minimum level of clearance), and the like. If the data do not meet the prespecified criteria, then the method advances to step 1006, where the computer is disabled. If the data do meet the prespecified criteria, then the method advances to step 1008.

In step 1008, a determination is made whether the potential user logged into the building security system at a prespecified building entrance. This step ensures that potential thieves who may have access to lesser or other building areas are not given access to computer 802 if they have managed to steal a computer access token. If step 1008 yields a negative determination (“NO”), then the method advances to step 1010, where the computer is disabled. If step 1008 yields a positive determination (“YES”), then the method advances to step 1012, where access is granted to the computer.

Thus, exemplary systems and methods consistent with embodiments of the present invention have the virtue of locking out unauthorized users who illegally obtain a key, token, or password for a computer. Unauthorized users who do not log into the building security system, e.g., those who sneak in behind others who properly enter a building (viz. “piggy backers”), are completely locked out of the computer system.

The exemplary systems and methods consistent with embodiments of the present invention may also screen out unauthorized users who may have proper access to the building, but who should not have access to the computer. For example, a person who is authorized to enter the building but unauthorized to use the computer would be denied access to the computer. Even if the person who is authorized for entry but unauthorized for computer use steals a computer use token from one with computer authorization, he or she still cannot use the system unless the authorized computer user happens to be logged into the building. Thus, one who illegally tries to access a computer with a stolen key, token, or password will be denied access when the authorized computer user associated with the stolen key, token, or password is not logged into the building, e.g., after normal business hours. Those skilled in the art will appreciate that disabling the computer 102 may further comprise detaining an unauthenticated computer access token and/or building access token in the computer access token reader 114.

Another aspect of embodiments of the present invention merges the function of the computer key, token, or password with the function of the building access token. Both access devices could be included on a single token, such as a Smart Card. In this way, the same token must be presented to the building security system and the computer in order to gain access to the computer.

Still another aspect of embodiments of the present invention is to require the user to enter the building through one or more specified entrances by presenting the building access token. Only if the user were to log into the building at the one or more specified building entrances would the user be able to gain access to the computer.

Other embodiments of the invention will be apparent to those skilled in the art from consideration of the specification and practice of the invention disclosed herein. Therefore, it is intended that the specification and examples be considered as exemplary only, with a true scope and spirit of the invention being indicated by the following claims.

What is claimed is:

1. A method for controlling access to a computer having an authorized computer access token and a computer access token reader in communication with the computer, the computer being housed in a building with entrances controlled by an authorized building access token and a building access token reader, the computer being in communication with the building access token reader, the method comprising:
logging in a person seeking computer access with the authorized building access token at the building access token reader;
checking for the authorized computer access token at the computer access token reader;
checking that the person associated with the authorized computer access token has logged into the building access token reader; and
disabling the computer if the person associated with the authorized computer access token has not logged in with the authorized building access token at the building access token reader.

2. The method of claim 1, wherein checking that the person associated with the authorized computer access token has logged into the building access token reader further comprises:
checking that the person associated with the computer access token has logged into the building access token reader at the entrance, which is a predetermined one of a plurality of building access points.

3. The method of claim 2, further comprising:
disabling the computer if the person associated with the authorized computer access token has not logged into the building access token reader at the predetermined one of the building access points.

4. The method of claim 2, further comprising:
revoking an authorization status of the authorized computer access token if the person associated with the computer access token logs into the building access token reader with the building access token at an alternative one of the building access points.

5. The method of claim 1, wherein checking for the authorized computer access token at the computer access token reader further comprises:
disabling the computer if the authorized computer access token has not been read by the computer access token reader.

6. The method of claim 1, wherein the authorized building access token and the authorized computer access token are the same.

7. The method of claim 6, wherein the authorized building access token and the authorized computer access token comprise at least one Smart Card.

8. The method of claim 1, wherein checking that the person associated with the authorized computer access token has logged into the building access token reader further comprises:
querying a building security system as to whether the person associated with the authorized computer access token has logged into the building security system and whether the person associated with the authorized computer access token is authorized to enter the building at that moment; and
receiving data from the building security system.

9. The method of claim 1, wherein checking that the person associated with the authorized computer access token has logged into the building access token reader further comprises:
querying a building security system;
receiving data from the building security system; and
determining whether the data meet prespecified criteria.

10. The method of claim 9, wherein the prespecified criteria comprise an amount of time since logging in at the building access token reader.

11. The method of claim 9, wherein the prespecified criteria comprise a level of security clearance.

12. The method of claim 7, wherein disabling the computer further comprises:
detaining the at least one Smart Card in the computer access token reader.

13. A system for protecting information when accessing a building with a plurality of entrances, comprising:
a computer housed in the building;
a plurality of building access token readers, each of which being respectively disposed substantially proximate to each of the entrances;
a computer access token reader in communication with the computer, the computer access token reader being in communication with the building access token readers;
a building access token; and
a computer access token,
wherein the computer is disabled if a person seeking computer access places the computer access token in the computer access token reader when the person associated with the computer access token has not logged in with the building access token at one of the building access token readers.

14. The system of claim 13, wherein the computer is disabled when the person associated with the authorized computer access token has not logged in with the authorized building access token at a specified one of the building access token readers.

15. The system of claim 14, wherein the computer access token and the building access token are the same.

16. The system of claim 15, wherein the building access token and the computer access token comprise at least one of a Smart Card, an RF tag, a device having a magnetic stripe, a retina from the person seeking access, a fingerprint from the person seeking access, and a palmprint of a person seeking access.

17. A computer-readable medium operative in a computer system having an authorized computer access token and a computer access token reader in communication with the computer system, the computer system being housed in a building with an entrance controlled by an authorized building access token and a building access token reader, the computer system being in communication with the building access token reader, and the computer-readable medium containing a program for protecting information within the computer system by carrying out steps comprising:
logging in a person seeking computer access with the authorized building access token at the building access token reader;
checking for the authorized computer access token at the computer access token reader;
checking that the person associated with the authorized computer access token has logged into the building access token reader; and
disabling the computer system if the person associated with the authorized computer access token has not logged in with the authorized building access token at the building access token reader.

18. The computer-readable medium of claim 17, wherein checking that the person associated with the authorized computer access token has logged into the building access token reader further comprises:
checking that the person associated with the computer access token has logged into the building access token reader at the entrance, which is a predetermined one of a plurality of building access points.

19. The computer-readable medium of claim 18, wherein the program further comprises disabling the computer if the person associated with the authorized computer access token has not logged into the building access token reader at the predetermined one of the building access points.

20. The computer-readable medium of claim 19, wherein the program further comprises revoking an authorization status of the authorized computer access token if the person associated with the computer access token logs into the building access token reader with the building access token at an alternative to one of the building access points.

21. The computer-readable medium of claim 17, wherein checking for the authorized computer access token at the computer access token reader further comprises:
disabling the computer if the authorized computer access token has not been read by the computer access token reader.

22. The computer-readable medium of claim 17, wherein the authorized building access token and the authorized computer access token are the same.

23. The computer-readable medium of claim 22, wherein the authorized building access token and the authorized computer access token comprise at least one Smart Card

24. The computer-readable medium of claim 17, wherein checking that the person associated with the authorized computer access token has logged into the building access token reader further comprises:
querying a building security system as to whether the person associated with the authorized computer access token has logged into the building security system and whether the person associated with the authorized computer access token is authorized to enter the building at that moment; and
receiving data from the building security system.

25. The computer-readable medium of claim 17, wherein checking that the person associated with the authorized computer access token has logged into the building access token reader further comprises:
querying a building security system;
receiving data from the building security system; and
determining whether the data meet prespecified criteria.

26. The computer-readable medium of claim 25, wherein the prespecified criteria comprise an amount of time since logging in at the building access token reader.

27. The computer-readable medium of claim 25, wherein the prespecified criteria comprise a level of security clearance.

28. The computer-readable medium of claim 23, wherein disabling the computer further comprises:
detaining the at least one Smart Card in the computer access token reader.
